(19) United States
(12) Patent Application Publication
(10) Pub. No.: US 2007/0293304 A1
(43) Pub. Date: Dec. 20, 2007

(54) Wagering Game Machine Audio Module Interface

(75) Inventors: Timothy C. Loose, Chicago, IL (US); Eric M. Pryzby, Skokie, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS GAMING, INC., Chicago, IL (US)

(21) Appl. No.: 11/568,942

(22) PCT Filed: May 10, 2005
(86) PCT No.: PCT/US05/16155

§ 371 Date: Aug. 20, 2007

Related U.S. Application Data
(60) Provisional application No. 60/570,709, filed on May 13, 2004.

(51) Int. Cl. G06F 17/00

(52) U.S. Cl. 463/25; 707/100; 709/213

(57) ABSTRACT

A computerized wagering game system has a gaming module comprising a processor and gaming code which is operable when executed on the processor to conduct a wagering game on which monetary value can be wagered, and a peripheral device interface. The gaming module is operable to send via the peripheral device interface instructions to play audio, and an audio module coupled to the gaming module via the peripheral device interface is operable to receive instructions via its peripheral device interface to play audio sounds.

### FIELD OF THE INVENTION

The invention relates generally to wagering gaming systems, and more specifically to computerized wagering game machines employing a peripheral device interface between a main CPU and an audio module.

### BACKGROUND OF THE INVENTION

A wide variety of gaming devices are now available to garners and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computer elements have been employed in gaming systems, from computerized animation to playing prerecorded sounds through a gaming system's speakers. These are carefully designed, along with the general theme and other elements of a gaming system, to attract the attention of garners and to provide a memorable gaming experience. These sounds are loaded within the computerized gaming machine and played through speakers to supplement the wagering game experience, much as is done with personal computer games and television-based video games.

In most systems, the sound information is stored in flash memory, hard disk storage, or other storage within the main processing module. The audio signal is loaded and directed to a sound card, attached to the processor, storage, and other components by a computer bus. The analog output of the sound card is then sent to an amplifier and to speakers. The audio in certain more complex wagering game machines is played via an audio processing module that has signal processing functionality beyond the audio control of the main processor or its associated components. In such examples, the analog audio signal output of a typical machine is received in the audio processor module, and is re-converted to a digital signal for processing. After processing, the digital signal is again converted to analog, and amplified before being sent to the speakers.

Because this method of employing audio processor module functionality outside the wagering game processing module requires multiple conversions between analog and digital formats, thereby increasing complexity, cost, and power consumption of such a system, it is desirable to more efficiently control reproduction of an audio signal in a wagering game machine.

### SUMMARY OF THE INVENTION

The present invention provides in one embodiment a computerized wagering game system having a gaming module comprising a processor and gaming code which is operable when executed on the processor to conduct a wagering game on which monetary value can be wagered, and a peripheral device interface. The gaming module is operable to send via the peripheral device interface instructions to play audio, and an audio module coupled to the gaming module via the peripheral device interface is operable to receive instructions via its peripheral device interface to play audio sounds.

### BRIEF DESCRIPTION OF THE FIGURES

FIG. 1 shows a computerized reel slot gaming system having a peripheral device interface linking an audio module, consistent with an embodiment of the present invention.

FIG. 2 is a block diagram of one embodiment of the prior art.

FIG. 3 is a block diagram of an example embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized wagering game system having a gaming module comprising a processor and gaming code which is operable when executed on the processor to conduct a wagering game on which monetary value can be wagered, and a peripheral device interface. The gaming module is operable to send via the peripheral device interface instructions to play audio, and an audio module coupled to the gaming module via the peripheral device interface is operable to receive instructions via its peripheral device interface to play audio sounds.

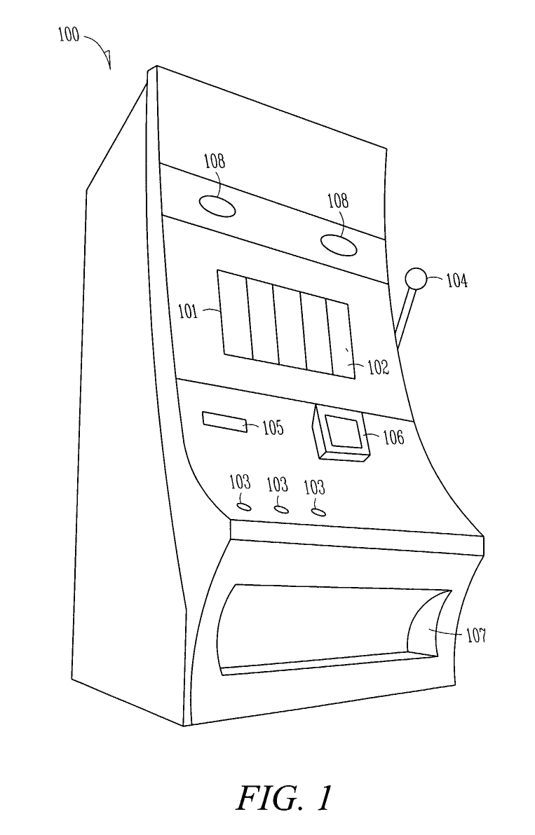

FIG. 1 illustrates a computerized wagering game machine, as may be used in an embodiment of the present invention. The computerized gaming system shown generally at 100 is a video gaming system, which displays information for at least one wagering game upon which monetary value can be wagered on video display 101. Alternate embodiments of the invention will have other game indicators, such as mechanical reels instead of the video graphics reels 102. The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a card reader 106, and winnings are returned via the returned value card or through the coin tray 107. The audio module receives symbols representing sounds to be played, such as a MIDI file, and creates the audio signal that is played through speakers 108.

This example embodiment of the invention uses MIDI to represent the sounds to be played due to the relative popularity of the MIDI format, and the ease with which MIDI files may be produced and managed. The MIDI standard is supported by most synthesizers, so sounds created on one synthesizer can be played and manipulated on another synthesizer, computer, or wagering game machine. Computers that have a MIDI interface can record sounds created by a synthesizer and then manipulate the data to produce new sounds. For example, a producer of a MIDI file could change the key of a composition with a single keystroke, could create a file that loops or repeats certain parts, and perform other such functions using commonly available software. Further, a number of software programs are available for composing and editing music that conforms to the MIDI standard, and offer a wide variety of composition functions. For example, when a musician plays a melody on a keyboard connected to a computer via a MIDI interface, a music program can translate what is played into a MIDI score. The widespread MIDI support in composition software reduces the burden of producing and formatting content, and so is used as an example here.

Other embodiments of the invention will use other symbols or scripts to represent various notes or sounds to be played. Such representative symbols range from complex, such as MIDI, to very simple, such as simply naming a note and duration. A “C” note played as a quarter note may be simply represented in a script with the symbol “C4”, for example, or may be represented as “5C4”, where 5 represents a specific octave. More complex scripts will add commands for changing volume, specifying specific instruments or sounds to be played back, attack/decay rates, and the like. Still further embodiments include the ability to play multiple notes and multiple instruments at the same time, enabling a more complex and rich audio presentation.

Sound effects are also represented by symbols in the scripting language in some embodiments, including the MIDI example described in detail above. Some MIDI instruments are defined such that they are not really a single instrument, but such that each note represents a different sound effect rather than a different note from the same instrument. MIDI instruments can further either be one of a standard instrument type, or can be defined by the user. This enables playing a wide range of sound effects in various complex arrangements by simply defining a MIDI instrument or using a preexisting MIDI instrument having the desired sound effects, and creating a MIDI score comprising symbols representing the various sound effects to be played. Embodiments not employing MIDI can represent sound effects even more simply, such as with a single character where a sufficiently small number of sounds are to be referenced, or by using more complex symbolic notation.

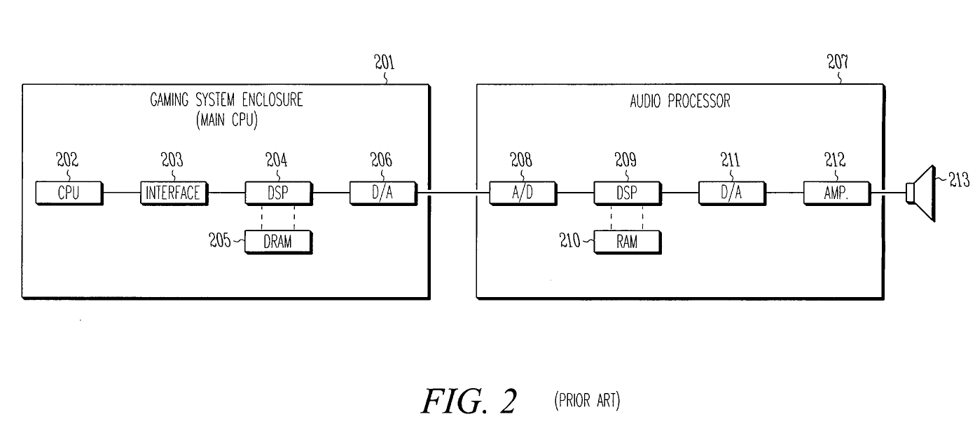

FIG. 2 is a block diagram of one example prior art computerized wagering game system. A gaming system main enclosure houses motherboard 201, which comprises a central processing unit (CPU) or processor 202, which is coupled to an audio system interface 203. The audio system comprises a digital signal processor (DSP) 204, which is coupled to dynamic random access memory (DRAM) 205. In some further embodiments of the invention, the DRAM 205 is used to store sounds, such as prerecorded audio or MIDI instrument data or other audio data. The DSP 204 performs various audio functions, and is a part of the production of the digital audio stream that is sent to the digital-to-analog converter (D/A converter or DAC) 206. The output of D/A 206 is an analog audio signal, as may be sent to a speaker, audio amplifier, or other such audio component.

A separate audio processor module 207 external to the main computer board 201 is in some embodiments housed in a separate enclosure, and includes its own signal processing and speakers. The analog audio signal is received by the audio module 207 via an analog-to-digital converter (A/D converter or ADC) 208, which provides a digital signal to the audio processor module's digital signal processor 209. The digital signal processor in some embodiments is designed to perform further signal processing functions, such as equalization of the signal for particular speakers, surround processing for a particular application, or other such functions. The DSP is coupled to memory 210, and the DSP's output is coupled to digital-to-analog converter 211. The output of the DAC 211 is an analog audio signal, which is coupled to amplifier 212 and speaker 213.

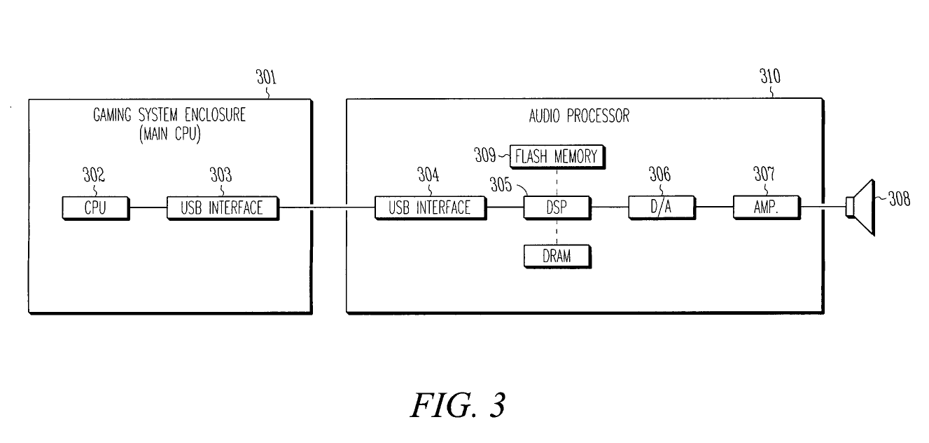

The embodiment of the invention shown in FIG. 3 illustrates how the topology of FIG. 2 can be made more efficient. Gaming system enclosure 301 comprises a central processing unit (CPU) 302 and a universal serial bus (USB) interface 303. The CPU in combination with software such as an audio device driver creates an audio signal and encodes it for transfer via the USB interface 303. The USB interface 303 is coupled via a USB cable to a second USB interface 304 in the audio processor module 305. The received audio signal is then processed in DSP 305 and converted to analog via the digital-to-analog converter 306. The analog audio signal is amplified in amplifier 307, and played through speaker or speakers 308.

In further embodiments of the invention, the audio signal carried over the USB interface comprises symbolic information such as MIDI data, which represent but do not actually contain the sounds to be played. In such an embodiment, flash memory 309 is employed to store MIDI sounds or other synthesized sound information. The flash memory in further embodiments stores prerecorded or sampled sounds, such as MP3, WAV, or other standard format sounds that the DSP loads in response to signals received via the USB interface and plays through the speakers 308 via other portions of the audio processor module 310.

The embodiment of the present invention illustrated in FIG. 3 therefore eliminates the conversion to analog that takes place between D/A converter 206 and A/D converter 208 in the prior art system of FIG. 2, and enables offloading synthesis of the audio signal from the gaming system's DSP 204 to the audio processor, where DSP 305 receives the MIDI instructions carried over the USB interface and synthesizes the audio signal.

The configuration of FIG. 3 further removes prerecorded sound and synthesized sound data such as MIDI instrument files out of the gaming system enclosure, and into the audio module. Because the gaming system's storage generally contains gaming code that is subject to security and verification to ensure that the code has not been altered to change game play, it must be handled somewhat differently than ordinary electronic data in traditional storage systems. For example, in some gaming machines, the entire gaming system code volume is digitally signed, and is checked against a hash value upon booting the system or upon loading the volume data. This takes considerable time and processing power, and is considerably lengthened by large volumes of stored audio or other data not central to the logical or operational aspects of the wagering game. By moving prerecorded sounds, MIDI synthesis data, and the like to the flash memory 309 within the audio processor module 310, it is removed from the storage of the gaming system's main module 301 and no longer needs to be handled with the same concerns for security.

This results in a faster startup time for the wagering game machine, and reduces the amount of memory and storage that must be integrated into the gaming system's main module 301. Moving the synthesis of various sounds from the gaming system's main module to the audio processor module 310 further reduces the processing load on the main module, reducing the demands placed upon the CPU 302 or upon a DSP such as 204 of FIG. 2.

The example embodiments of the present invention shown here illustrate how an audio module coupled to the main module of a wagering game machine via a peripheral device interface such as USB can reduce the demands placed upon the gaming system's main module, including storage, memory, processing, and startup time and verification demands. Storing sounds and related synthesis data within the audio module enables the audio module to produce sound in response to relatively simple symbolic communication received via the peripheral device interface, such as MIDI data. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized wagering game system, comprising:
a gaming module comprising a processor and gaming code which is operable when executed on the processor to conduct a wagering game on which monetary value can be wagered, and further comprising a peripheral device interface, the gaming module operable to send via the peripheral device interface instructions to play audio; and
an audio module coupled to the gaming module via the gaming module's peripheral device interface and an audio module peripheral device interface, the audio module operable to receive instructions via its peripheral device interface to play audio sounds.

2. The computerized wagering game system of claim 1, wherein the audio sounds to be played comprise sounds stored in the audio module.

3. The computerized wagering game system of claim 1, wherein the peripheral device interface is a Universal Serial Bus (USB) interface.

4. The computerized wagering game system of claim 1, wherein the instructions to play audio comprise Musical Instrument Digital Interface (MIDI) data.

5. The computerized wagering game system of claim 4, wherein the MIDI data further comprises system exclusive messages operable to control devices attached to the audio module.

6. The computerized wagering game system of claim 5, wherein the devices attached to the audio module comprise at least one light.

7. The computerized wagering game system of claim 4, wherein the MIDI data further comprises system exclusive messages indicating a prerecorded sound is to be played.

8. The computerized wagering game system of claim 1, wherein the audio module and the gaming module are housed in separate enclosures.

9. A method of operating a computerized wagering game system, comprising:
sending via a peripheral device interface of a gaming module instructions to play audio;
receiving in a peripheral device interface of an audio module the instructions sent from the gaming module;
retrieving from storage within the audio module audio data corresponding to the received instructions; and
playing in the audio module audio based on the retrieved audio data;
wherein the gaming module further comprises a processor and gaming code which is operable when executed on the processor to conduct a wagering game on which monetary value can be wagered.

10. The method of claim 9, wherein the storage within the audio module comprises at least one of flash memory and a hard disk drive.

11. The method of claim 9, wherein the retrieved audio data comprises prerecorded audio.

12. The method of claim 9, wherein the retrieved audio data comprises sound synthesis data.

13. The method of claim 9, wherein the peripheral device interface is a Universal Serial Bus (USB) interface.

14. The method of claim 9, wherein the instructions to play audio comprise Musical Instrument Digital Interface (MIDI) data.

15. The method of claim 14, wherein the MIDI data further comprises system exclusive messages operable to control devices attached to the audio module.

16. The method of claim 15, wherein the devices attached to the audio module comprise at least one light.

17. The method of claim 14, wherein the MIDI data further comprises system exclusive messages indicating a prerecorded sound is to be played.

18. The method of claim 9, wherein the audio module and the gaming module are housed in separate enclosures.

19. A machine-readable medium with instructions thereon, the instructions when executed operable to cause a computerized wagering game system to:
send via a peripheral device interface of a gaming module instructions to play audio;
receive in a peripheral device interface of an audio module the instructions sent from the gaming module;
retrieve from storage within the audio module audio data corresponding to the received instructions; and
play in the audio module audio based on the retrieved audio data;
wherein the gaming module further comprises a processor and gaming code which is operable when executed on the processor to conduct a wagering game on which monetary value can be wagered.

20. The machine-readable medium of claim 19, wherein the storage within the audio module comprises at least one of flash memory and a hard disk drive.

21. The machine-readable medium of claim 19, wherein the retrieved audio data comprises prerecorded audio.

22. The machine-readable medium of claim 19, wherein the retrieved audio data comprises sound synthesis data.

23. The machine-readable medium of claim 19, wherein the peripheral device interface is a Universal Serial Bus (USB) interface.

24. The machine-readable medium of claim 19, wherein the instructions to play audio comprise Musical Instrument Digital Interface (MIDI) data.

25. The machine-readable medium of claim 24, wherein the MIDI data further comprises system exclusive messages operable to control devices attached to the audio module.

26. The machine-readable medium of claim 25, wherein the devices attached to the audio module comprise at least one light.

27. The machine-readable medium of claim 24, wherein the MIDI data further comprises system exclusive messages indicating a prerecorded sound is to be played.

28. The machine-readable medium of claim 19, wherein the audio module and the gaming module are housed in separate enclosures.

29. A data structure, comprising:
symbols representing sounds, the symbols interpretable within a wagering game machine audio module to play sounds corresponding to the symbols; and
symbols representing machine control functions, the machine control functions interpretable within a wagering game machine to control wagering game components other than audio components.

30. The data structure of claim 29, wherein the game components other than audio components comprise at least one light.

31. The data structure of claim 29, wherein the symbols comprise Musical Instrument Digital Interface (MIDI) data.

32. The data structure of claim 29, wherein the symbols representing machine control functions comprise system exclusive MIDI messages.
